(19) United States
(12) Patent Application Publication
(10) Pub. No.: US 2008/0207235 A1
(43) Pub. Date: Aug. 28, 2008

(54) Method for Servicing Short Message Service Message Receiving Confirmation, Mobile Communication Terminal and Service System for the Performing the Same

(76) Inventor: Sung-Yong Choi, Seoul (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/915,170

(22) PCT Filed: Oct. 27, 2005
(86) PCT No.: PCT/KR05/03585

§ 371 Date: Nov. 21, 2007

(30) Foreign Application Priority Data
Aug. 22, 2005 (KR) 10-2005-0076987

(51) Int. Cl. H04Q 7/20; H04M 3/42; H04Q 7/22; H04B 1/38

(52) U.S. Cl. 455/466; 455/414.1; 455/412.2; 455/566

(57) ABSTRACT

The present invention provides a method of providing an SMS message reception confirmation service that enables a sending party to confirm whether a receiving party has checked a transmitted SMS message, and provides a mobile terminal and a service system for performing the same. A sending terminal provides a message confirmation request SMS message to a receiving terminal via a mobile communication network, receives a message confirmation SMS message, and verifies an SMS message stored in a sent message box as a reception confirmation, and the message confirmation SMS message is provided when the receiving terminal receives the message confirmation request SMS message. The receiving terminal stores a message confirmation request SMS message when the message confirmation request SMS message is received via the mobile communication network, and the receiving terminal provides a message confirmation SMS message to the sending terminal when the stored message confirmation SMS message is verified.

### TECHNICAL FIELD

The present invention relates to a method of providing a short message service (SMS) message reception confirmation service, and a mobile terminal and a service system for performing the same. More particularly, the present invention relates to a method of providing an SMS message reception confirmation service, which is capable of allowing a sender of an SMS message to check whether or not a recipient received the message, and a mobile terminal and a service system for performing the same.

### BACKGROUND ART

In code division multiple access (CDMA) communication, short message service (SMS) data transmission is natively supported, and thus is easily implemented in communication systems and mobile terminals.

SMS has the same function as a two-way pager, and is capable of receiving a simple text message, voice mail notification, and transmitting a message. The communication system and the mobile terminal basically transmit and receive SMS messages using a data burst message as described in the IS-95-A standard. The message length is restricted to about 150 bytes for receiving and about 100 bytes for sending.

Services using SMS are divided into message-receiving Mobile-Terminated (MT) SMS, message-sending Mobile-Oriented (MO) SMS, a cell broadcast service (CBS), which is almost the same as that of a two-way pager, and data-on-demand services, which use characteristics native to two-way communication. SMS may also be used for various remote control applications.

Nowadays, SMS is widely used, owing to widespread use of cellular phones and mobile terminals.

Generally, in an SMS service, a sending party sends an SMS message to a receiving party using a mobile terminal, and the SMS message is transmitted to a mobile terminal of the receiving party via a mobile communication network. In this process, when the SMS message sent by the sending party is normally received by an SMSC server that controls an SMS service of the mobile communication network, only a notice that the message was properly received by receiving party is composed, and the SMS message transmission process is completed when the STVS message is transmitted to the receiving party.

Thus, communication between the sending party and the receiving party may have a problem of low accuracy because the sending part cannot verify whether the receiving part has checked the SMS message.

### DISCLOSURE OF THE INVENTION

Technical Problem

The present invention provides a method of providing a short message service (SMS) message reception confirmation service that is convenient for an SMS message user by providing information about whether a receiving party has checked the SMS message sent by a sending party to the sending part.

The present invention also provides a mobile terminal for performing the method of providing the SMS message reception confirmation service.

The present invention also provides a service system for performing the method of providing the SMS message reception confirmation service.

Technical Solution

A method of providing a short message service (SMS) message reception confirmation service according to an example embodiment of the present invention includes receiving an SMS message via a mobile communication network, verifying a transmitted message corresponding to a message confirmation SMS message as a message confirmation when the SMS message is verified as the message confirmation SMS message, storing a message confirmation request SMS message in a received message box when the SMS message is verified as the message confirmation request SMS message, and transmitting the message confirmation SMS message for notifying a user's reception of the received SMS message to a sender via the mobile communication network when the user confirms the stored message confirmation request SMS message.

In an example embodiment, the message confirmation request SMS message may be identified by using a value assigned to a teleservice identifier of a transport layer.

In an example embodiment, the message confirmation SMS message is identified by using a value assigned to a teleservice identifier of a transport layer.

A method of displaying a short message service (SMS) message reception confirmation of a mobile terminal according to another example embodiment of the present invention includes displaying a sent SMS message list on a display panel of a sending party and marking a reception confirmation on an SMS message display row corresponding to the sent SMS message list.

In an example embodiment, marking the reception confirmation may include displaying check boxes corresponding to the rows of the lists of the display panel, respectively, and marking a check in the check box of a reception-confirmed row. Marking the reception confirmation may be performed by displaying characters of the reception-confirmed row with a different color. Marking the reception confirmation may be performed by underlining characters of the reception-confirmed row.

A mobile terminal has a built-in program according to an example embodiment of the present invention. The program has functions including receiving an SMS message via a mobile communication network, verifying a transmitted message corresponding to a message confirmation SMS message as a message confirmation when the SMS message is verified as the message confirmation SMS message, storing a message confirmation request SMS message in a received message box when the SMS message is verified as the message confirmation request SMS message, and transmitting the message confirmation SMS message for notifying a user's reception of the received SMS message to a sender via the mobile communication network when the user confirms the stored message confirmation request SMS message.

A mobile terminal having a communication channel set by a medium of a mobile communication network according to an example embodiment of the present invention includes a radio frequency (RF) circuit and a control unit. The RF circuit sets the mobile communication network and the communication channel. The control unit controls to store a message confirmation request SMS message in a sent message box and provide the message confirmation request SMS message to the mobile communication network via the communication channel when the message confirmation request SMS message is composed in the case of a message transmission mode, and controls to verify a stored message confirmation SMS message as a reception confirmation, when the stored message confirmation SMS message exists, by comparing the message confirmation SMS message delivered in case of the reception of the message confirmation request SMS message by the receiving party with a plurality of message confirmation SMS messages stored in the sent message box.

In an example embodiment, the control unit may control to store the message confirmation request SMS message in a sent message box and to send an alarm by using the mobile communication network and the set communication channel, and control to provide the message confirmation request SMS message to the sending part via the mobile communication network when the message confirmation request SMS message is confirmed by the user.

In an example embodiment, the mobile terminal may further include a keypad for composing the message confirmation request SMS message and a display unit for displaying a number or character when the corresponding number or character is input through the keypad. The display unit may display a check box together with the message confirmation request SMS message.

A mobile terminal for sending an SMS message and receiving an SMS reception confirmation signal corresponding to the sent SMS message according to an example embodiment of the present invention includes a display window for displaying information including characters and symbols, a sent SMS message list indication unit indicated on the display window, and a reception confirmation indication unit for making a reception confirmation mark corresponding to the sent SMS message list when the SMS reception confirmation signal is received.

An SMS message reception confirmation system includes a sending terminal and a receiving terminal connected by a communication channel through a mobile communication network.

The sending terminal provides a message confirmation request SMS message to the receiving terminal via the mobile communication network, receives a message confirmation SMS message, and verifies an SMS message stored in a sent message box as a reception confirmation, and the message confirmation SMS message is provided when the receiving terminal receives the message confirmation request SMS message. The receiving terminal stores a message confirmation request SMS message when the message confirmation request SMS message is received via the mobile communication network, and the receiving terminal provides a message confirmation SMS message to the sending terminal when the stored message confirmation SMS message is verified.

Effect of the Invention

According to a method of providing a short message service (SMS) message reception confirmation service and a mobile terminal and a system for performing the same, the sending party is capable of knowing whether the receiving party has confirmed an SMS message or not after the sending party has transmitted the corresponding SMS message.

### BRIEF DESCRIPTION OF THE DRAWINGS

The above and other advantages of the present invention will become more apparent by describing in detail example embodiments thereof with reference to the accompanying drawings, in which:

FIG. 1 is a schematic block diagram illustrating a service system for performing a method of providing a short message service (SMS) message reception confirmation service according to an example embodiment of the present invention;

FIG. 2 is a block diagram illustrating a mobile terminal having a function of an SMS message reception confirmation service according to an example embodiment of the present invention;

FIGS. 3 through 5 are diagrams illustrating user interface menus displayed on a sending mobile terminal related to the SMS message reception confirmation service according to an example embodiment of the present invention;

FIG. 6 is a diagram illustrating an SMS protocol stack for the SMS message according to an example embodiment of the present invention;

FIG. 7 is a diagram illustrating a message architecture of each layer as defined in the IS-637 standard;

FIG. 8 is a table showing teleservice identifier values and corresponding contents illustrated in FIG. 7 as may be adopted by mobile communication companies;

FIG. 9 is a flow chart illustrating the operation of the mobile terminal of either the sending or receiving party illustrated in FIG. 1; and

FIG. 10 is a diagram illustrating a user interface menu displayed on the mobile terminal of the receiving party for verifying whether the message confirmation SMS message is transmitted or not during the process illustrated in FIG. 9.

### BEST MODE FOR CARRYING OUT THE INVENTION

It should be understood that the example embodiments of the present invention described below may be variously modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

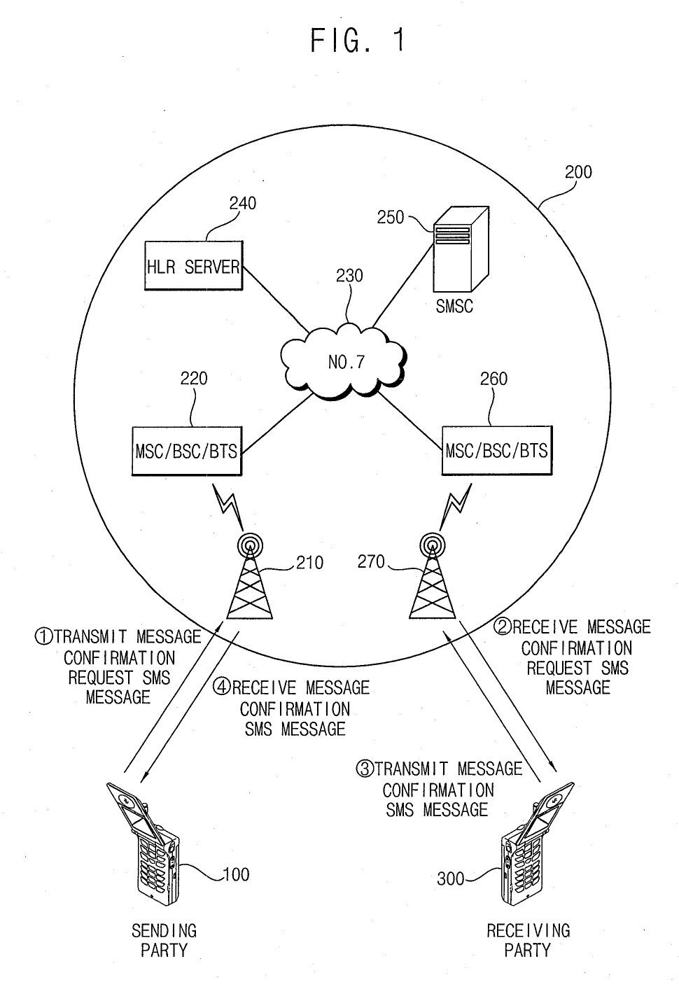

FIG. 1 is a schematic block diagram illustrating a service system for performing a method of providing a short message service (SMS) message reception confirmation service according to an example embodiment of the present invention.

Referring to FIG. 1, the SMS message reception confirmation service system includes a sending terminal 100, a mobile communication network 200 and a receiving terminal 300. For the convenience of explanation, a part that first provides an SMS message is defined as a sending part, and an act of transmitting an SMS message by the sending part is defined as sending, and a part to which the SMS is provided is defined as a receiving part, and an act of receiving the SMS message is defined as receiving.

The sending terminal 100 provides a message confirmation request SMS message to the receiving terminal 300 via the mobile communication network 200, and is provided a message confirmation SMS message to verify an SMS message stored in a sent message box as a message confirmation, when the receiving terminal 300 receives the message confirmation request SMS message.

The mobile communication network 200 includes a sending base station 210, a sending exchange 220, a No. 7 mobile communication network 230, a home location register (HLR) server 240, a short message service center (SMSC) server 250, a receiving exchange 260, and a receiving base station 270. The mobile communication network 200 sets a communication channel between the sending terminal 100 and the receiving terminal 300. The sending exchange 220 includes a mobile switching sensor (MSC), a base station controller (BSC) and a base transceiver station (BTS).

The HLR server 240 manages an application of the SMS message reception confirmation service and information (location information, possibility of reception, additional services, etc.) about the receiving terminal.

The SMSC server 250 provides an SMS message to the receiving terminal 300, and provides the message confirmation SMS message to the sending terminal 100 when the SMS message is verified.

The receiving terminal 300 stores the message confirmation request SMS message when the message confirmation request SMS message is provided via the mobile communication network 200, and provides a message confirmation SMS message to the sending terminal 100 when the stored message confirmation request SMS message is verified.

A sending terminal or a receiving terminal according to an example embodiment of the present invention commonly includes software programmed for performing the following functions.

The program includes functions for receiving an SMS message via a mobile communication network, verifying a transmitted message corresponding to a message confirmation SMS message as a message confirmation when the SMS message is verified as the message confirmation SMS message, storing a message confirmation request SMS message in a received message box when the SMS message is verified as the message confirmation request SMS message, and transmitting the message confirmation SMS message for notifying a user's reception of the received SMS message to a sender via the mobile communication network when the user confirms the stored message confirmation request SMS message.

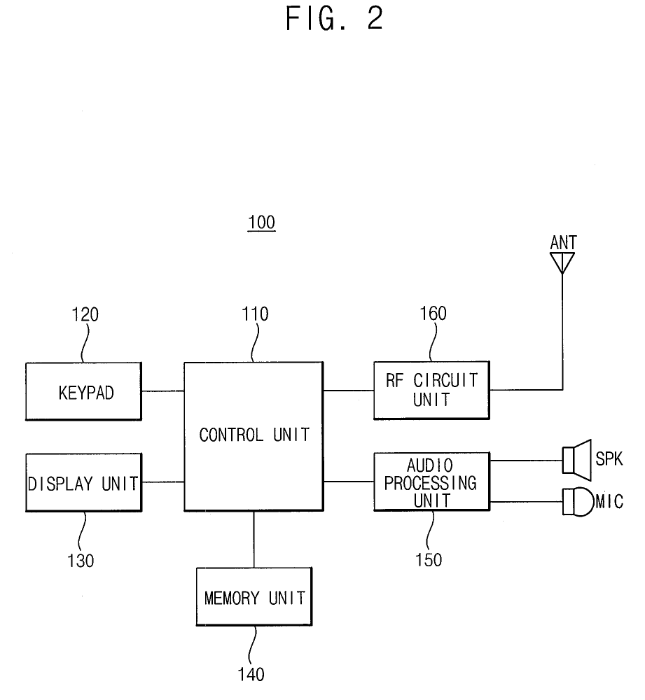

FIG. 2 is a block diagram illustrating a mobile terminal having a function of an SMS message reception confirmation service according to an example embodiment of the present invention.

Referring to FIG. 2, the mobile terminal having a function of an SMS message reception confirmation service 100 includes a control unit 110, a keypad 120, a display unit 130, a memory unit 140, an audio processing unit 150, and a radio frequency (RF) circuit unit 160.

The control unit 110 controls all functions of the mobile terminal 100 through a process of receiving or transmitting signals and/or data between the keypad 120, the display unit 130, the memory unit 140, the audio processing unit 150 and the RF circuit unit 160.

The control unit 110 controls to store a composed SMS confirmation request SMS message in a sent message box and provide the composed SMS confirmation request SMS message to the mobile communication network by using the set communication channel when the message confirmation request SMS message is composed by a user in the case of an SMS message transmission mode. For example, the sent message box is stored in the memory unit 140.

The control unit 110 controls to verify a stored corresponding message confirmation request SMS message as a reception confirmation, when there exists the stored message confirmation request SMS message by comparing a message confirmation SMS message provided when the receiving part receives the message confirmation request SMS message with a plurality of message confirmation request SMS messages stored in the sent message box.

The control unit 110, in the case of a reception mode, controls to receive a message confirmation request SMS message provided by the sending part via the mobile communication network and the set communication channel and to store the received message confirmation request SMS message in the received message box and for sending an alarm. For example, the received message box is stored in the memory unit 140.

The control unit 110 controls to provide the message confirmation SMS message to the receiving part via the mobile communication network, when the user verifies the stored message confirmation request SMS message.

The keypad 120 is an input means for transmitting the user's commands to the control unit 110, and includes function buttons for performing functions and general button for inputting numbers or characters, and transmits the user's commands to the control unit 110.

The display unit 130 displays information from the mobile terminal, a menu interface that shows various functions, an input interface for inputting characters and numbers, and an output interface thereupon according to the control unit 110. Thus, the user can perform preferred functions based on the interfaces.

The memory unit 140 stores a driving program that drives the functions processed by the control unit 110, and a convenient program that implements user-oriented convenience and various basic functions. The memory unit 140 generally includes flash memory, random-access memory (RAM) and read-only memory (ROM).

The flash memory includes a basic real-time operating system and software for signal processing of the mobile terminal. The program is operated by reading variables and status from the ROM.

The ROM is implemented as an electrically erasable programmable read-only memory (EEPROM), stores non-volatile data that is capable of electrically being erased or stored, and performs input/output operations according to commands from the control unit 110.

Such data as a number assignment module (NAM) parameter and other storable data that are unerasable and semi-permanent are stored in the ROM.

In addition, the flash memory is a non-volatile memory that is fast in processing speed and data-preserving, and upgraded software is stored in the flash memory when upgrading the software of the mobile terminal.

Particularly, the flash memory includes a program performing a function that adds a message confirmation request message to a message to be sent to the receiving part, and a function that transmits a message confirmation SMS message notifying the sending part that the received message has been checked at the moment the receiving part verifies the received message from the sending part.

In addition, the memory unit 140 includes messages, and system information that the mobile terminal requires for operating the system.

The audio processing unit 150 converts analog voices that the user records by using a microphone MIC into digital data to transmit the digital data to the control unit 110, or processes data from an external source to output analog voices through a speaker SPK.

The RF circuit unit 160 sets a communication channel with the mobile communication network, receives a phone call, a text message or voice data from an external terminal through an antenna ANT, and transmits the received phone call, the message or the voice data to the control unit 110, or transmits data stored in the memory unit 140 to the receiving terminal through the antenna ANT.

The mobile terminal described above may provide accurate communication between the sending party and the receiving party, because the mobile terminal has a function that adds a message confirmation request message to a message to be sent to the receiving part, and a function that transmits a message confirmation SMS message notifying the sending part that the received message has been checked at the moment the receiving part verifies the received message from the sending part.

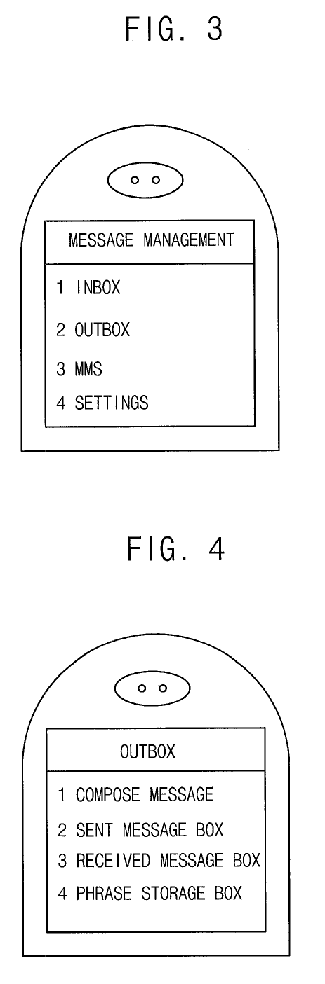

FIGS. 3 through 5 are diagrams illustrating user interface menus displayed on a sending mobile terminal related to the SMS message reception confirmation service according to an example embodiment of the present invention.

First, when the user selects a message management mode, a menu having directories, including an inbox, an outbox, a multimedia message service (MMS) and settings, is displayed as illustrated in FIG. 3.

When the user selects the outbox mode in the menu in FIG. 3 by operating the keypad or the buttons, a menu having sub-directories, including compose message, a sent message box, a received message box, and a phrase storage box, is displayed as illustrated in FIG. 4.

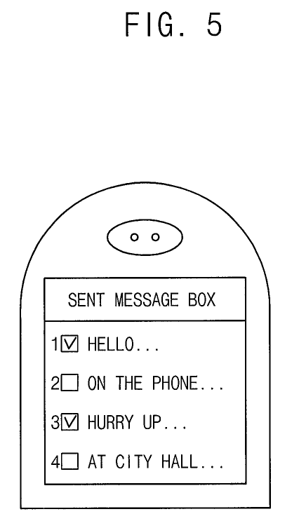

When the user selects a sent message box connection mode in the menu in FIG. 4 by operating the keypad or the buttons, SMS messages corresponding to a list of transmitted SMS messages that the user has sent is displayed as illustrated in FIG. 5. In this case, separate check boxes are indicated next to the transmitted SMS messages of the displayed transmission list. The check box informs the user of confirmation states of the transmitted SMS messages by a method of displaying an active or inactive state.

In FIG. 5, a reception confirmation is made by marking the check boxes, but a reception confirmation may also be made by displaying characters of a reception-confirmed row with a different color or underlining the characters of the reception-confirmed row.

The transmitted SMS messages may be displayed in sequence according to message transmission time from new to old, or unconfirmed SMS messages by the receiving party may be displayed.

In FIG. 5, both the reception-confirmed messages and reception-unconfirmed messages are displayed in the sent message box, but a confirmed message box and an unconfirmed message box may be displayed on different screens by including an extra sub-directory.

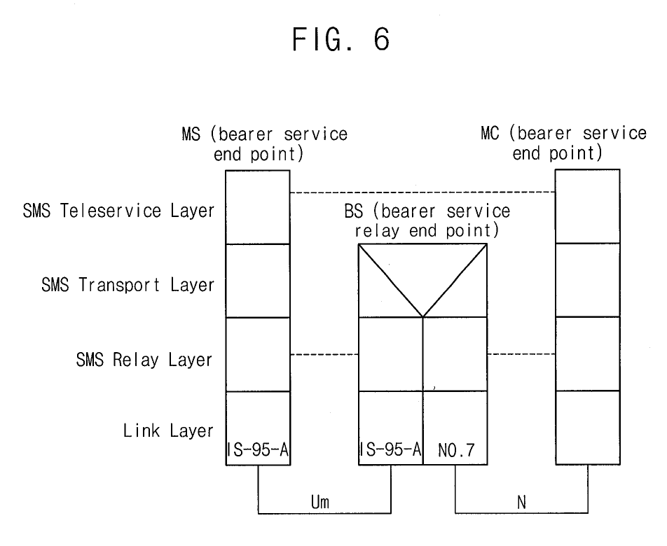

FIG. 6 is a diagram illustrating an SMS protocol stack for the SMS message.

Referring to FIG. 6, SMS is formed on the basis of a data burst message of the IS-95-A standard (or link layer), the length of the transmitted message is 200 bytes, e.g., 100 Korean characters at most.

The SMS protocol architecture is transmitted as a paging channel of a forward channel or a forward traffic channel, and in the case of a reverse channel, is transmitted to an access channel or a data burst message of a reverse traffic channel. When the user is in a phone call mode, a multiplex option is operated that enables data transmission during a voice phone call.

The SMS illustrated in FIG. 6, sets a data burst message in a link layer, a relay layer sets a transmission channel according to a message length, such as an idle mode or a traffic mode of the mobile terminal.

The function of the relay layer is described below.

The relay layer receives a message of the transport layer and transmits the message to the next directed relay point or end point. The relay layer generates an error indication to the transport layer, delivers the message to the transport layer, and connects to the IS-95-A Link Layer for message relaying and controlling the IS-95-A Link Layer.

The transport layer basically sets termination points between a message center (MC) and a mobile terminal, and receives bearer data from a teleservice layer to constitute a message. The detailed operation will be described below.

The transport layer receives a message parameter from a teleservice layer to constitute a transport, layer message, and delivers the transport layer message to a relay layer by using an appropriate relay layer service primitive. In addition, when acknowledgements to all transmitted messages are received, the transport layer notifies the relay layer of the acknowledgements, and when an error of the relay layer is reported, the transport layer notifies the teleservice layer of the error of the relay layer. In addition, the transport layer receives the SMS message from the relay layer to deliver the SMS message to the teleservice layer, and performs an operation of processing for authentication stated expressly in the IS-637 standard when the authentication is enabled in the mobile communication network.

The teleservice layer supports basic SMS functions by using standard subparameters of a short message data parameter of the transport layer. That is, when the mobile terminal transmits an SMS User Ack message, the teleservice layer transmits a destination address to the transport layer, and when the mobile terminal receives an SMS delivery message, the teleservice layer transmits the SMS delivery message to the user in the case of a replay option being set, and the teleservice layer appropriately selects a MESSAGE_ID value when sending an SMS submit message.

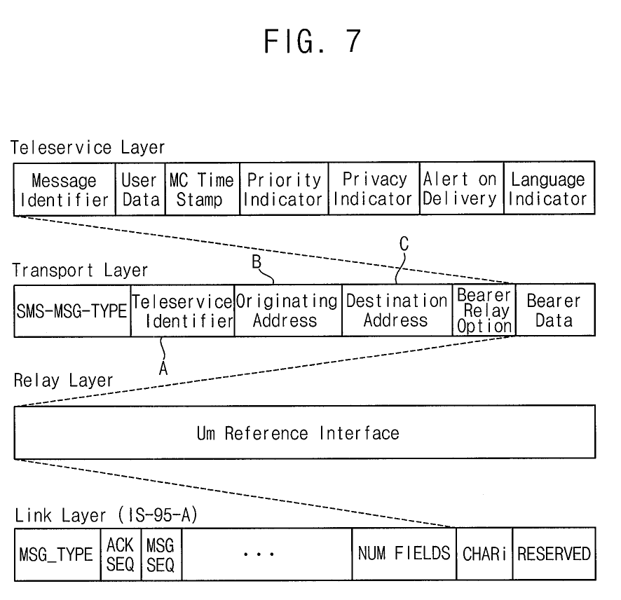

FIG. 7 is a diagram illustrating a message architecture of each layer as defined in the IS-637 standard.

Referring to FIG. 7, a CHARi message of a data burst message (or a link layer) has a capsuled SMS parameter, and the capsuled SMS parameter is analyzed and transmitted to upper layers.

The transport layer is set on the basis of the IS-95-A data burst message that performs the role of a link layer via an Um interface of the relay layer. The transport layer message includes a teleservice identifier (A) for identifying services such as voice mail and general messaging, an originating address (B), a destination address (C), a bearer reply option and bearer data.

The bearer data constitutes the teleservice layer, and the teleservice layer provides practical services. The teleservice layer includes user data including contents of a received message, an MC time stamp of the corresponding message, a priority indicator, a privacy indicator, an alert on delivery indicator and a language indicator.

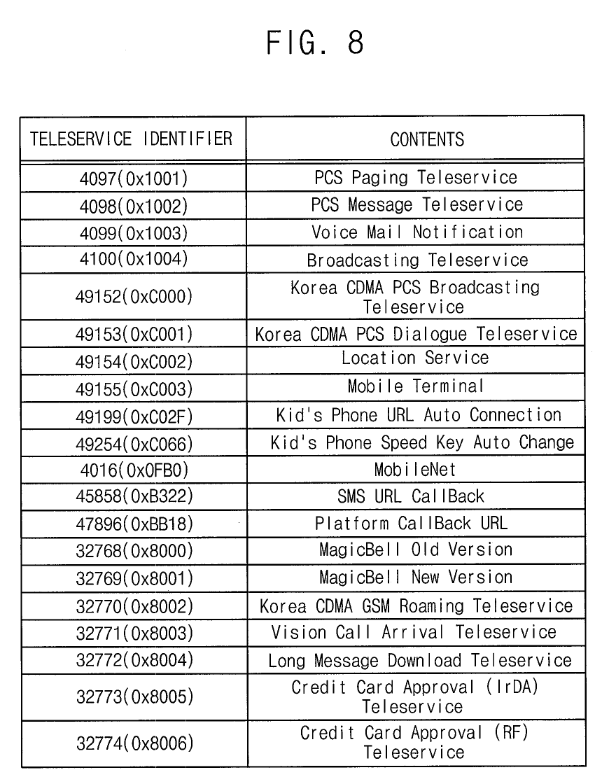

FIG. 8 is a table showing teleservice identifier values and corresponding contents illustrated in FIG. 7 as may be adopted by mobile communication companies.

Referring to FIG. 8, the teleservice identifier denotes a PCS paging teleservice when the teleservice identifier value corresponds to 4097 (or 0×1001); the teleservice identifier denotes a PCS message teleservice when the teleservice identifier value corresponds to 4098 (or 0×1002); and the teleservice identifier denotes a voice mail notification service when the teleservice identifier value corresponds to 4099 (or 0×1003). In addition, the teleservice identifier denotes a broadcasting teleservice when the teleservice identifier value corresponds to 4100 (or 0×1004); the teleservice identifier denotes a Korean CDMA PCS broadcasting teleservice when the teleservice identifier value corresponds to 49152 (or 0×C000); and the teleservice identifier denotes a Korean CDMA PCS dialogue teleservice when the teleservice identifier value corresponds to 49153 (or 0×C001). In addition, the teleservice identifier denotes a location service when the teleservice identifier value corresponds to 49154 (or 0×C002); the teleservice identifier denotes a mobile terminal when the teleservice identifier value corresponds to 49155 (or 0×C003); the teleservice identifier denotes a Kid's Phone URL auto-connection service when the teleservice identifier value corresponds to 49199 (or 0×C02F); and the teleservice identifier denotes a Kid's Phone speed key auto-change service when the teleservice identifier value corresponds to 49254 (or 0×C066).

In addition, the teleservice identifier denotes a MobileNet when the teleservice identifier value corresponds to 4016 (or 0×0FB0); the teleservice identifier denotes an SMS URL callback service when the teleservice identifier value corresponds to 45858 (or 0×B322); and the teleservice identifier denotes a platform callback URL service when the teleservice identifier value corresponds to 47896 (or 0×BB18).

The message confirmation service (MCS) is accomplished by assigning different values to the teleservice identifier from the values shown in FIG. 8. Since the values already assigned to the teleservice identifier are operated as a rule, it is preferable to perform the MCS by setting appropriate, unused values.

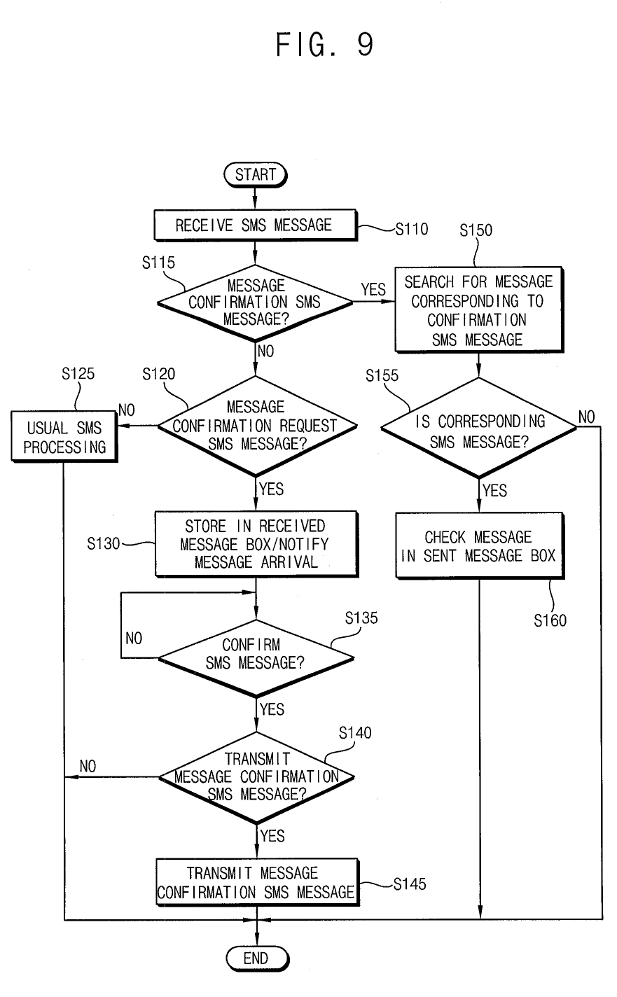

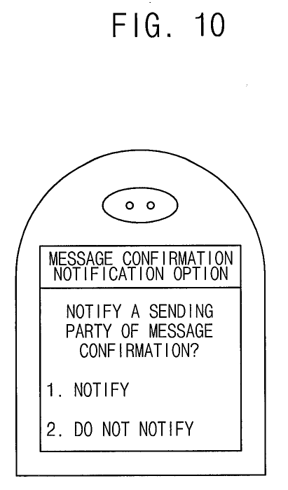

FIG. 9 is a flow chart illustrating the operation of the mobile terminal of either the sending or receiving party illustrated in FIG. 1. FIG. 10 is a diagram illustrating a user interface menu displayed on the mobile terminal of the receiving party for verifying whether the message confirmation SMS message is transmitted or not during the process illustrated in FIG. 9.

Referring to FIGS. 1 through 10, after an SMS message is received from the mobile communication network 200 (step S110), whether the teleservice identifier included in the received SMS message is a message confirmation SMS message (step S115) or not is verified.

When the teleservice identifier is verified as a non-message confirmation SMS message in step S115, the corresponding mobile terminal is identified as a receiving party, and whether the teleservice identifier is a message confirmation request SMS message or not is verified (step S120).

When the teleservice identifier is verified as a non-message confirmation request SMS message in step S120, the same process as that of the previous SMS message service is performed according to the teleservice identifier, and the process ends (step S125).

When the teleservice identifier is verified as a message confirmation request SMS message in step S120, the received SMS message is stored in the received message box, and the user is notified of an arrival of the SMS message (step S130).

Subsequently, whether the user confirms the SMS message in the received message box or not is verified (step S135). When the user confirms the SMS message in step S135, whether a message confirmation SMS message is transmitted or not is verified (step S140). That is, as illustrated in FIG. 10, an additional screen is displayed on the mobile terminal of the receiving party, and the receiving party selects by manipulating the keypad or buttons at the displayed screen.

It is preferable in this process that the screen, in which the receiving party verifies whether or not the message confirmation SMS message is transmitted, not be displayed on the mobile terminal of the sending party.

When the message confirmation SMS message is verified as not having been transmitted in step S140, the process ends. When the message confirmation SMS message is verified as having been transmitted, the message confirmation SMS message informing that the receiving party has received the SMS message is transmitted to the sending party (step S145).

The teleservice identifier of the message confirmation SMS message identifies a message confirmation SMS message by storing other set values in addition to parameters for the usual SMS message service and parameters for message confirmation request SMS messages.

In addition, an originating address included in the transport layer of the corresponding message confirmation request SMS message is stored as a destination address of the message confirmation SMS message. Locations of the originating address and the destination address are as illustrated in FIG. 7.

When the received SMS message is verified as a non-message confirmation SMS message in step S115, the corresponding mobile terminal is identified as a receiving party. Thus, the receiving party compares the originating address illustrated in FIG. 7 and the user data with values stored in the received message box to search for the corresponding message confirmation request SMS message and to check for the existence of the corresponding message (step S150 andstep S155).

When the corresponding message confirmation request SMS message is verified as being in the sent message box, the operation in which the receiving party confirms the message is performed and the process ends (step S160).

The check boxes as illustrated in FIG. 5 are displayed on the sending mobile terminal by the operation in which the receiving party confirms the message.

When a message confirmation request SMS message corresponding to a message confirmation SMS message is verified as not being in the sent message box, the process ends.

For example, the limited memory capacity of the mobile terminal is not capable of storing a lot of data. Therefore, predetermined numbers of the transmitted SMS messages are stored in the sent message box. Practically, as a newly transmitted SMS message is stored in the sent message box, the oldest transmitted SMS message is deleted by a first in, first out (FIFO) method.

Having described the example embodiments of the present invention and its advantages, it is noted that various changes, substitutions and alterations can be made herein without departing from the spirit and scope of the invention as defined by appended claims.

### INDUSTRIAL APPLICABILITY

A mobile terminal according to an example embodiment of the present invention adopts a function that adds a message confirmation request message to a message to be sent to the receiving part, and a function that transmits a message confirmation short message service (SMS) message notifying the sending part that the received message has been checked at the moment the receiving part verifies the received message from the sending part.

Therefore, since the sending party is notified whether the receiving party has actually confirmed the SMS message, accurate communication and convenience for users may be increased.

1. A method of providing a short message service (SMS) message reception confirmation service, comprising:
receiving an SMS message via a mobile communication network;
verifying a transmitted message corresponding to a message confirmation SMS message as a message confirmation when the SMS message is verified as the message confirmation SMS message;
storing a message confirmation request SMS message in a received message box when the SMS message is verified as the message confirmation request SMS message; and
transmitting the message confirmation SMS message for notifying a user's reception of the received SMS message to a sender via the mobile communication network when the user confirms the stored message confirmation request SMS message.

2. The method of claim 1, wherein the message confirmation request SMS message is identified by using a value assigned to a teleservice identifier of a transport layer.

3. The method of claim 1, wherein the message confirmation SMS message is identified by using a value assigned to a teleservice identifier of a transport layer.

4. The method of claim 1, further comprising:
selecting a transmission or a non-transmission of the message confirmation SMS message when the user confirms the stored message confirmation request SMS message, and wherein the message confirmation SMS message for notifying the user's reception of the received SMS message is transmitted to the sender via the mobile communication network when the transmission is selected, and wherein the message confirmation SMS message is not transmitted when the non-transmission is selected.

5. A method of displaying an SMS message reception confirmation of a mobile terminal, comprising:
displaying a sent SMS message list on a display panel of a sending party; and
marking a reception confirmation on an SMS message display row corresponding to the sent SMS message list.

6. The method of claim 5, wherein marking the reception confirmation comprises:
displaying check boxes corresponding to the rows of the lists of the display panel, respectively; and
marking a check in the check box of the reception-confirmed row.

7. The method of claim 5, wherein marking the reception confirmation is performed by displaying characters of the reception-confirmed row with a different color.

8. The method of claim 5, wherein marking the reception confirmation is performed by underlining characters of the reception-confirmed row.

9. A mobile terminal having a built-in program, the program having functions comprising:
receiving an SMS message via a mobile communication network;
verifying a transmitted message corresponding to a message confirmation SMS message as a message confirmation when the SMS message is verified as the message confirmation SMS message;
storing a message confirmation request SMS message in a received message box when the SMS message is verified as the message confirmation request SMS message; and
transmitting the message confirmation SMS message for notifying a user's reception of the received SMS message to a sender via the mobile communication network when the user confirms the stored message confirmation request SMS message.

10. A mobile terminal having a communication channel set by a medium of a mobile communication network, comprising:
a radio frequency (RF) circuit unit configured to set the mobile communication network and the communication channel;
a control unit configured to control to store a message confirmation request SMS message in a sent message box and provide the message confirmation request SMS message to the mobile communication network via the communication channel when the message confirmation request SMS message is composed in the case of a message transmission mode, and configured to control to verify a stored message confirmation SMS message as a reception confirmation, when the stored message confirmation SMS message exists, by comparing the message confirmation SMS message delivered in case of the reception of the message confirmation request SMS message by the receiving party with a plurality of message confirmation SMS messages stored in the sent message box.

11. The mobile terminal of claim 10, wherein the control unit is configured to control to store the message confirmation request SMS message in a sent message box and to send an alarm by using the mobile communication network and the set communication channel, and configured to control to provide the message confirmation request SMS message to the sending part via the mobile communication network when the message confirmation request SMS message confirmed by the user.

12. The mobile terminal of claim 10, further comprising,
a keypad for composing the message confirmation request SMS message; and
a display unit for displaying a number or character when the corresponding number or character is input through the keypad; and
wherein the display unit is configured to display a check box together with the message confirmation request SMS message.

13. The mobile terminal of claim 12, further comprising,
a memory unit for storing the message confirmation request SMS message, and wherein the memory unit is configured to store and delete newly-composed message confirmation request SMS messages by a first in, first out (FIFO) method.

14. The mobile terminal of claim 10, wherein the control unit is configured to identify the message confirmation request SMS message by using a value assigned to a teleservice identifier of a transport layer.

15. The mobile terminal of claim 10, wherein the control unit is configured to identify the message confirmation SMS message by using a value assigned to a teleservice, identifier of a transport layer.

16. A mobile terminal for sending SMS message and receiving an SMS reception confirmation signal corresponding to the sent SMS message, comprising:
a display window for displaying information including characters and symbols;
a sent SMS message list indication unit for displaying sent SMS messages on the display window; and
a reception confirmation indication unit for making a reception confirmation mark corresponding to the sent SMS message list when the SMS reception confirmation signal is received.

17. An SMS message reception confirmation system including a sending terminal and a receiving terminal connected by a communication channel through a mobile communication network:
wherein the sending terminal provides a message confirmation request SMS message to the receiving terminal via the mobile communication network, receives a message confirmation SMS message, and verifies an SMS message stored in a sent message box as a reception confirmation, the message confirmation SMS message being provided when the receiving terminal receives the message confirmation request SMS message; and
wherein the receiving terminal stores a message confirmation request SMS message when the message confirmation request SMS message is received via the mobile communication network, and the receiving terminal provides a message confirmation SMS message to the sending terminal when the stored message confirmation SMS message is verified.
